(19) United States
(12) Patent Application Publication
(10) Pub. No.: US 2025/0166869 A1
(43) Pub. Date: May 22, 2025

(54) ASSEMBLY FOR MOUNTING ONE OR MORE LINES, AND SYSTEM

(71) Applicant: ABB Schweiz AG, Baden (CH)

(72) Inventor: Marcus Wadstein, Västerås (SE)

(21) Appl. No.: 18/839,188

(22) PCT Filed: Feb. 24, 2022
(86) PCT No.: PCT/EP2022/054668

§ 371 Date: Aug. 16, 2024

(51) Int. Cl. H01B 7/40; H01B 7/00

(52) U.S. Cl. CPC H01B 7/40; H01B 7/0045

(57) ABSTRACT

An assembly for being mounted to a target structure, the assembly having one or more lines; and a holder including a holding part holding the one or more lines; an attachment part fixed with respect to the holding part, the attachment part being configured to mechanically connect the holder to the target structure; and a lifting structure for being engaged by an industrial robot to lift the assembly, the lifting structure being fixed with respect to the attachment part. A system including an assembly and at least one secondary holder is also provided.

### TECHNICAL FIELD

The present disclosure generally relates to mounting of one or more lines to a target structure. In particular, an assembly for being mounted to a target structure and comprising one or more lines, and a system comprising such assembly, are provided.

### BACKGROUND

A wide range of electric equipment contain electric cable harnesses. Although attempts have been made to automize mounting of cable harnesses, these are today mounted manually to a large extent. One major reason for this is that automated processes have difficulties handling the flexibility of the cable harnesses.

JP H0541334 U discloses a temporary holding device for a wire harness comprising a plurality of wires. The holding device comprises a plurality of locking pins. A plurality of fittings is attached to the wire harness. Each fitting comprises a locking hole for receiving a locking pin such that the wire harness can be temporarily held by the holding device. The holding device enables a robot to grip the wire harness with a specialized tool shaped as the harness itself. When the holding device and the wire harness have been transported together to a work site, the robot can remove the wire harness from the holding device and move the wire harness to a mounting position.

Although the holding device in JP H0541334 U enables a wire harness to be transported to a work site while maintaining a shape of the wire harness, the holding device is not used when mounting the wire harness and does not enable the wire harness to be mechanically connected to a target structure. The holding device also constitutes scrap in the wire harness mounting process that needs to be handled.

### SUMMARY

One object of the invention is to provide an improved assembly for being mounted to a target structure.

A further object of the invention is to provide an improved system comprising such assembly.

These objects are achieved by the assembly and the system according to the claims.

The invention is based on the realization that by providing an assembly comprising a cable harness and a holder including a holding part holding the cable harness, an attachment part for mechanically connecting the holder to a target structure, and a gripping structure for being gripped by an industrial robot, the assembly including the cable harness can be lifted, moved and connected to the target structure by the industrial robot using a single grip. A degree of automation can thereby be increased.

According to a first aspect, there is provided an assembly for being mounted to a target structure, the assembly comprising one or more lines; and a holder comprising a holding part holding the one or more lines; an attachment part fixed with respect to the holding part, the attachment part being configured to mechanically connect the holder to the target structure; and a lifting structure for being engaged by an industrial robot to lift the assembly, the lifting structure being fixed with respect to the attachment part.

The assembly can be lifted, moved and mechanically connected to the target structure by means of the attachment part while the lifting structure is engaged by the industrial robot. Thus, the assembly enables elimination of any use of tools to secure an attachment interface between the attachment part and the target structure. The combination of the lifting structure and the attachment part can also eliminate a need to rely on the dexterity of humans in many implementations. The assembly therefore enables an increased automation of mounting of the one or more lines to the target structure.

Each line may be flexible. In case a plurality of lines is provided, the plurality of lines may be flexible together. Moreover, in case a plurality of lines is provided, the lines may be parallel.

Each line may be an electric cable, such as a signal cable or a power cable. As one possible alternative, each line may be a fluid line, such as a hydraulic line.

The holding part may be adjustable, e.g. such that the holding part can be tightened around the one or more lines. The holding part may comprise a cable tie. The holding part may be made of plastic. In case a plurality of lines is provided, the holding part may hold these lines together in a bundle. Moreover, the holding part may be substantially circular, or circular, in this case.

The lifting structure may be configured to be gripped by the industrial robot. The lifting structure may thus be a gripping structure. The lifting structure may be a handle. The lifting structure may be flat. The lifting structure may protrude with a length that is at least 30% of a largest interior distance of the holding part.

The attachment part may be configured to be mechanically connected to the target structure by relative movement between the attachment part and the target structure. The attachment part may define a main extension direction away from the one or more lines. The attachment part may protrude with a length that is at least 20% of a length of a largest interior distance of the holding part. The target structure may for example be one or more walls of an electric device.

The assembly may comprise a holder base. In this case, the holding part may be fixed with respect to the holder base. The holder base may or may not constitute the attachment part.

The holding part may be positioned between the lifting structure and the attachment part. This enables a further improved mounting of the assembly. For example, the attachment part can be brought into narrow spaces while the lifting structure, on the opposite side of the holding part with respect to the attachment part, is engaged by the industrial robot. This can be done without necessarily using a very small end effector of the industrial robot to engage the lifting structure. One example of such narrow space is a U-shaped cable passage of the target structure. The arrangement of the holding part between the lifting structure and the attachment part also contributes to a compact design of the holder.

The assembly may comprise a cable harness. In this case, the one or more lines may be a plurality of electric cables of the cable harness. The cable harness may be flexible.

The assembly may further comprise a stabilizing element fixed with respect to the holding part and supporting the one or more lines outside of the holding part. With this variant, the assembly can be lifted, moved and mechanically connected to the target structure by means of the attachment part while the lifting structure is engaged by the industrial robot and while the stabilizing element maintains a shape of the one or more lines.

Since the stabilizing element enables a desired shape of the one or more lines to be maintained, the stabilizing element enables the assembly including the one or more lines to be handled as a rigid package. Moreover, features of the assembly can be more efficiently identified by machine vision when at least a portion of the one or more lines is kept in a desired shape by the stabilizing element.

The stabilizing element provides rigidity to the one or more lines externally of the holding part. The stabilizing element may thus be stiffer than the one or more lines. The stabilizing element may be elongated. Additionally, the stabilizing element may be flat. The stabilizing element may be straight, bent and/or curved. A length of the stabilizing element along the one or more lines may be at least five times, such as at least ten times, a length of the holding part along the one or more lines. The stabilizing element may support the one or more lines on two opposite sides outside of the holding part. The stabilizing element may for example be made of metal or plastic.

The assembly may further comprise a compartment element having a compartment through which the stabilizing element can pass. The compartment element may be configured such that the stabilizing element can pass therethrough in at least two different directions, such as in two perpendicular directions. The holding part may be fixed with respect to the compartment element. The compartment element may be positioned between the holding part and the holder base. The holder base, the holding part and/or the compartment element may constitute a base element.

The stabilizing element may be hidden from view by the one or more lines in at least one viewing direction. The stabilizing element may be visible in at least one viewing direction. The stabilizing element may be hidden from view by the cable harness in at least one viewing direction. In these ways, a compact design is provided that further facilitates mounting of the one or more lines in tight spaces.

The one or more lines may be positioned between the lifting structure and the stabilizing element. This enables the lifting structure to be pulled with a reduced risk of changing the shape of the one or more lines.

The lifting structure may be aligned with the attachment part along the one or more lines. Also, this variant contributes to a compact design and facilitates positioning of the attachment part in narrow spaces.

The attachment part may comprise one or more attachment features configured to attach to a target element of the target structure by snap-fit. In this way, a mechanical connection between the holder and the target structure can be established. Each attachment feature may be an attachment hole for receiving a holder latch of the target element. Alternatively, each attachment feature may be a latch for engaging with a hole in the target element.

The attachment part may comprise an orienting holder feature defining an unequivocal orientation of the holder with respect to the target element. To this end, the orienting holder feature may be aligned with a corresponding orienting target feature of the target element. Due to the unequivocal orientation of the holder with respect to the target feature, the one or more lines can more easily be positioned as intended with respect to the target structure.

The holder may comprise a molded body molded over the one or more lines. The use of a molded body efficiently enables various different designs of the holder, such as different shapes and/or colors. The design of the holder can in turn be associated with its identity. A human or a robot can thereby efficiently recognize the identity of the holder. This contributes to a less error-prone mounting and demounting of the assembly. A further advantage of the molded body is that the holder is made tamper proof since a line cannot be removed without breaking the molded body. The molded body may further be molded over the stabilizing element.

In one variant, the molded body is molded over the holding part. In this way, the one or more lines can be held stably by the holding part during molding. The molded body may be molded over a base element as described herein.

The molded body may comprise the lifting structure. Alternatively, or in addition, the molded body may comprise the attachment part. Alternatively, or in addition, the molded part may partly or entirely constitute the holding part.

According to a second aspect, there is provided a system comprising the assembly according to the first aspect, and at least one secondary holder, wherein each secondary holder comprises a holding part holding the one or more lines; an attachment part fixed with respect to the holding part, the attachment part being configured to mechanically connect the secondary holder to the target structure; and a lifting structure for being engaged by the industrial robot to lift the secondary holder, the lifting structure being fixed with respect to the attachment part. Each secondary holder may be of the same type as the holder of the first aspect.

In case the assembly comprises the stabilizing element, the stabilizing element may be fixed with respect to the holding part of each secondary holder. The stabilizing element enables the system including one or more relatively long lines to be handled as a substantially rigid, or rigid, package. The stabilizing element and the one or more lines may be straight all the way between at least two holders. The one or more lines do thereby not have to be connected to the stabilizing element between two holders.

The stabilizing element may comprise a plurality of alignment features, such as alignment holes. Each alignment feature may define a unique position of one of the holders with respect to the stabilizing element.

Each lifting structure may have the same positional and orientational relationship with its associated attachment part.

The system may further comprise a plurality of target elements. In this case, each attachment part may be configured to be attached to a unique target element. By virtue of the attachment between each attachment part and the respective target element, a mechanical connection between the system and the target structure can be established. Each target element may be made of plastic. The target elements may form parts of the target structure.

Each target element may be a socket. Each target element may comprise one or more engaging features, each for engaging a unique attachment feature of the attachment part. Each engaging feature may be released, for example with a tool, to remove the assembly from the target structure.

Each attachment part may be configured to be attached to a unique target element by snap-fit. In this case, each engaging feature may be a holder latch.

Each pair of attachment part and target element may define an unequivocal relative orientation. For example, each attachment part may comprise an orienting holder feature configured to be aligned with a corresponding orienting target feature of the target element.

### BRIEF DESCRIPTION OF THE DRAWINGS

Further details, advantages and aspects of the present disclosure will become apparent from the following description taken in conjunction with the drawings, wherein:

FIG. 1: schematically represents a perspective view of a base element;

FIG. 2: schematically represents a top view of a stabilizing element;

FIG. 3: schematically represents a perspective view of the base element and a cable harness;

FIG. 4: schematically represents a perspective view of the base element, the cable harness and the stabilizing element;

FIG. 5a: schematically represents a perspective view of one example of an assembly comprising a holder;

FIG. 5b: schematically represents a further perspective view of the assembly;

FIG. 6a: schematically represents a perspective cross-sectional view of a target element;

FIG. 6b: schematically represents a top view of the target element;

FIG. 7: schematically represents a perspective view of a target structure;

FIG. 8: schematically represents a perspective view of the target structure when comprising the target element;

FIG. 9: schematically represents a perspective view of the assembly in FIG. 5a mechanically connected to the target structure in FIG. 8;

FIG. 10: schematically represents a perspective view of the assembly and a tool for disconnecting the assembly from the target structure; and

FIG. 11: schematically represents a perspective view of a system comprising the assembly and a plurality of secondary holders.

### DETAILED DESCRIPTION

In the following, an assembly for being mounted to a target structure and comprising one or more lines, and a system comprising such assembly, will be described. The same or similar reference numerals will be used to denote the same or similar structural features.

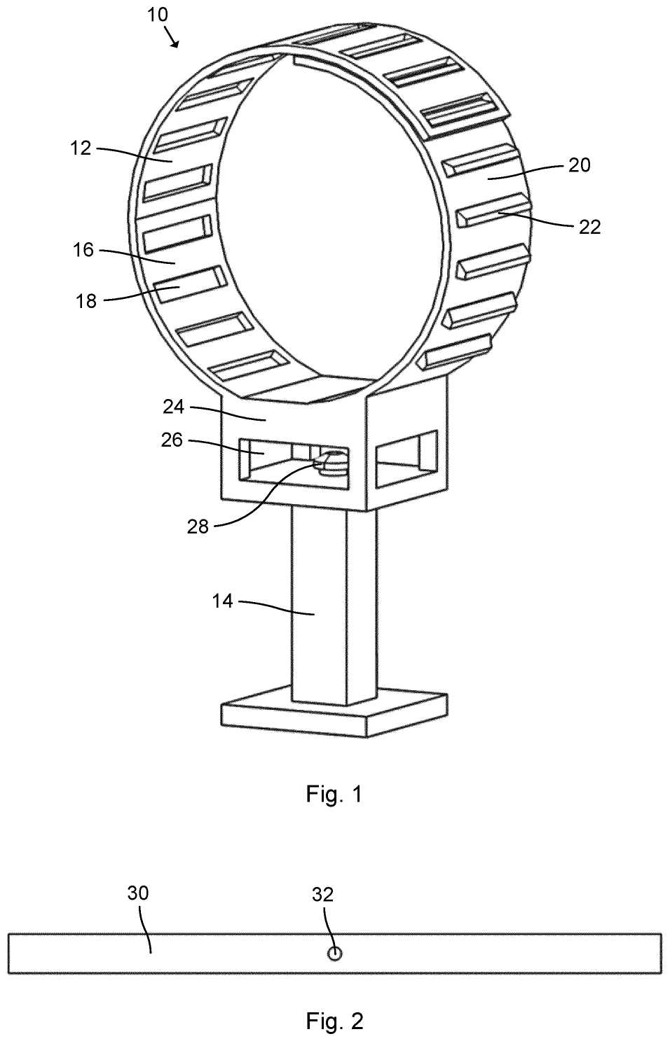

FIG. 1 schematically represents a perspective view of a base element 10. The base element 10 comprises a holding part 12 and a holder base 14. The holding part 12 of this specific example comprises a flexible first strap 16 having a plurality of strap holes 18 and a flexible second strap 20 having a plurality of ridges 22. Each strap hole 18 is configured to receive one of the ridges 22. By selectively mating one or more ridges 22 with one or more strap holes 18, a desired interior size of the holding part 12 can be set and the holding part 12 is prevented from expanding.

The base element 10 of this example further comprises a compartment element 24. The compartment element 24 is here positioned between the holding part 12 and the holder base 14. The compartment element 24 comprises a compartment 26. In this example, the compartment element 24 comprises four openings into the compartment 26. The four openings form two pairs of two aligned openings, here in two perpendicular directions.

The compartment element 24 further comprises a pin 28 inside the compartment 26. Each of the first and second straps 16, 20 is fixed to the compartment element 24. The base element 10 of this example is made of plastic.

FIG. 2 schematically represents a top view of an optional stabilizing element 30. The stabilizing element 30 of this example is straight, flat and elongated. The stabilizing element 30 here comprises a pre-punched alignment hole 32. The alignment hole 32 is one example of an alignment feature. The alignment hole 32 is configured to receive the pin 28. After being led through the compartment 26, the stabilizing element 30 can be pushed down such that the pin 28 snaps through the alignment hole 32. The stabilizing element 30 can be inserted through the compartment 26 in two different, here perpendicular, orientations relative to the holding part 12.

By providing a plurality of alignment holes 32, the positions of a plurality of base elements 10 along the stabilizing element 30 can be accurately predetermined. The stabilizing element 30 may for example be made of metal such as steel, or plastic such as polyvinyl chloride (PVC) or Poly(methyl methacrylate) (PMMA). It should be noted that the scales in FIGS. 1 and 2 are different.

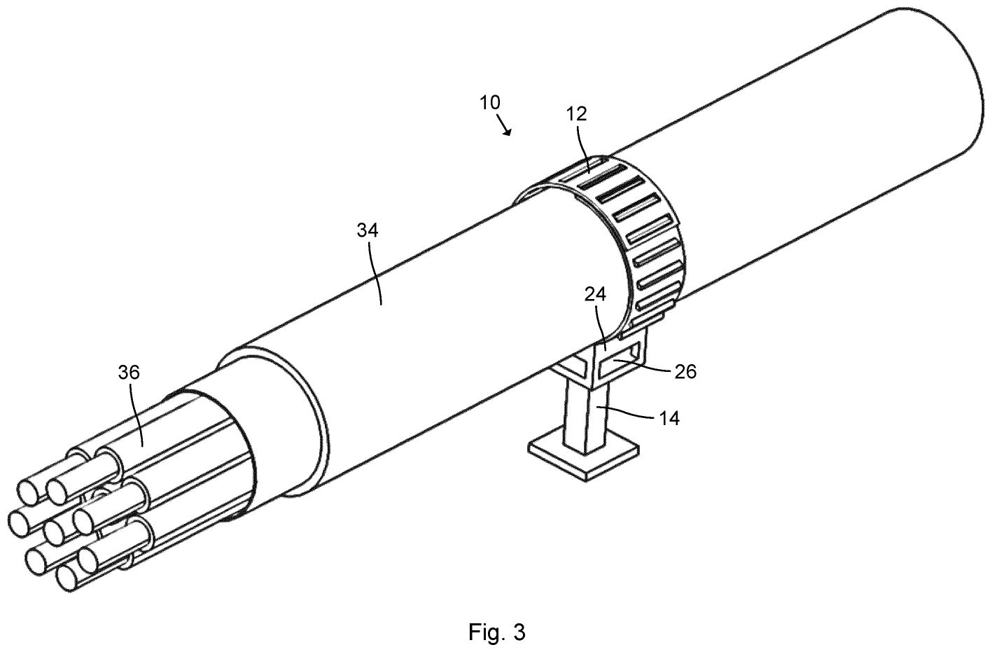

FIG. 3 schematically represents a perspective view of the base element 10 and a cable harness 34. The holding part 12 holds the cable harness 34 tightly. As shown in FIG. 3, the holding part 12 has a thin profile around the cable harness 34. The cable harness 34 comprises a plurality of electric cables 36. The cables 36 are examples of lines according to the present disclosure. The cable harness 34 is flexible but is here illustrated in a straight condition.

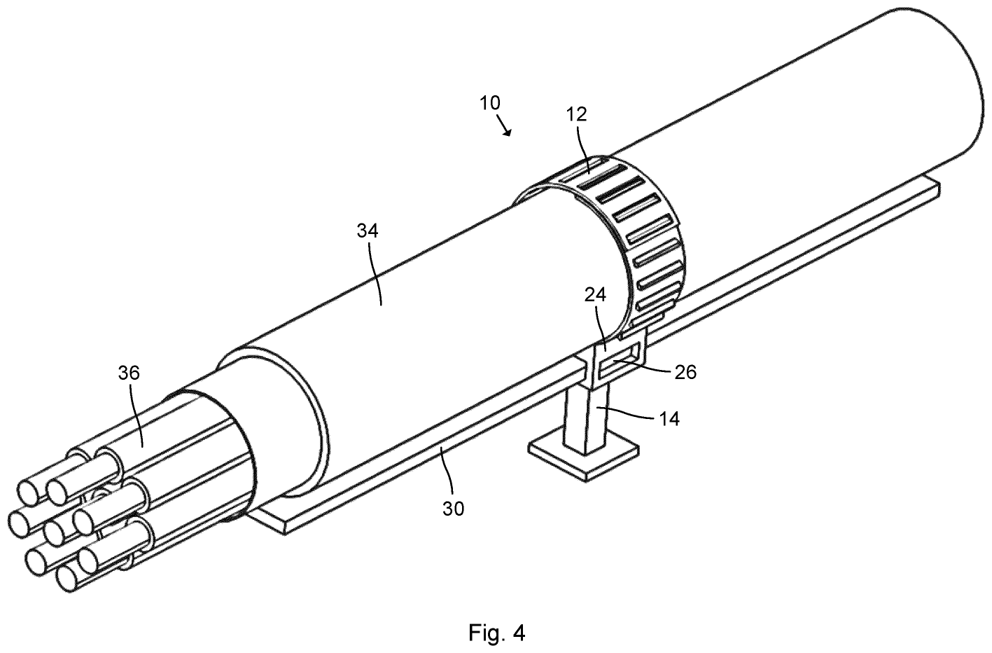

FIG. 4 schematically represents a perspective view of the base element 10, the cable harness 34 and the stabilizing element 30. The stabilizing element 30 is fixed in the compartment element 24. The stabilizing element 30 is thereby also fixed with respect to the cable harness 34 adjacent to the holding part 12. In FIG. 4, the stabilizing element 30 has been inserted through the compartment 26 and fixed to the base element 10 by engagement between the pin 28 and the alignment hole 32. The stabilizing element 30 is positioned below the cable harness 34 (in FIG. 4) and supports the cable harness 34 on each side of the holding part 12.

In this example, the stabilizing element 30 passes through the compartment 26 in a direction parallel with the cable harness 34. As an alternative, the stabilizing element 30 may pass through the compartment 26 in a direction transverse to the part of the cable harness 34 shown in FIG. 4. In this way, the stabilizing element 30 may for example support a curved part of the cable harness 34 outside of the holding part 12.

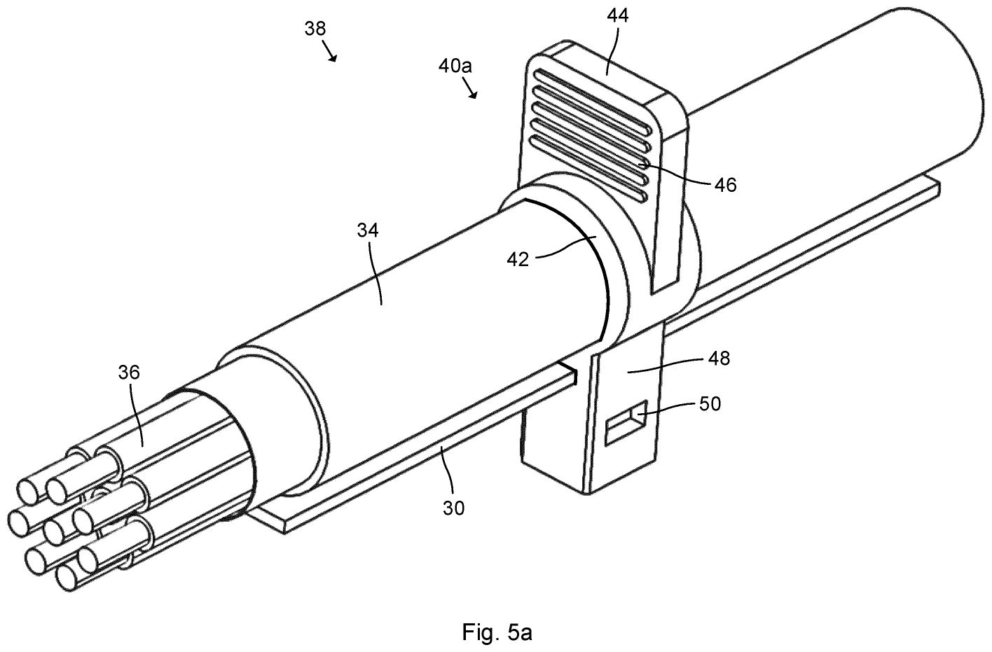

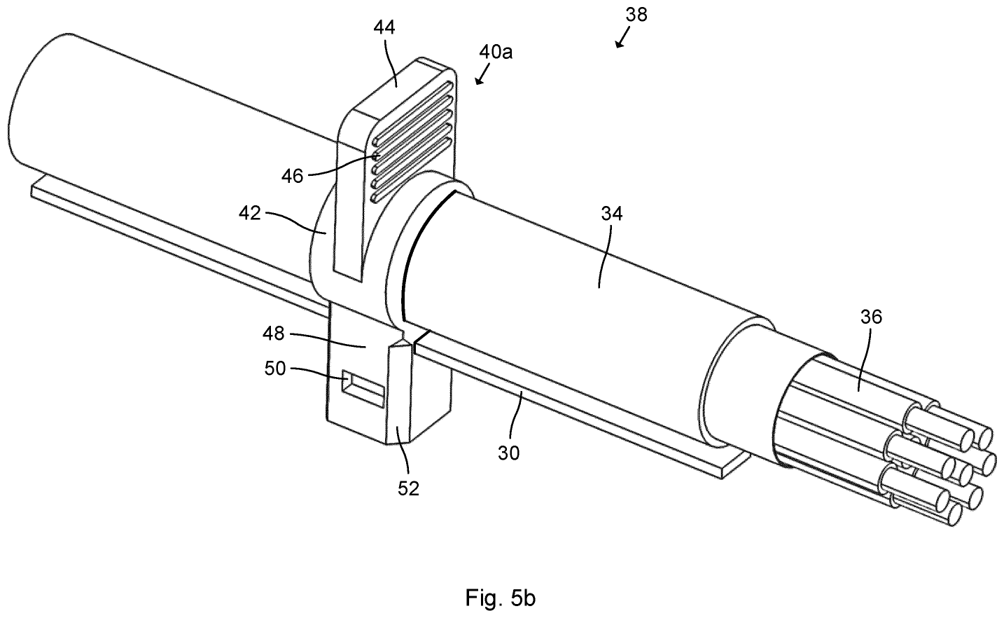

FIG. 5a schematically represents a perspective view of one example of an assembly 38, and FIG. 5b schematically represents a further perspective view of the assembly 38. With collective reference to FIGS. 5a and 5b, the assembly 38 comprises the cable harness 34, the stabilizing element 30 and a holder 40a. The holder 40a of this specific example comprises the base element 10 and a molded body 42 molded over the entire base element 10. The thin profile of the holding part 12 enables a compact shape of the molded body 42.

The molded body 42 is also molded over the cable harness 34 and over the stabilizing element 30. Due to the holding part 12, and since the stabilizing element 30 is fixed with respect to the cable harness 34 adjacent to the holding part 12, the shape of the cable harness 34 is accurately controlled prior to molding and the molded body 42 can be precisely positioned with respect to the cable harness 34. The molded body 42 may be molded by plastic injection molding. As can be gathered from FIGS. 5a and 5b, the stabilizing element 30 is hidden from view by the cable harness 34 when the assembly 38 is viewed from above. On the other hand, the stabilizing element 30 is visible in each view of the assembly 38 in FIGS. 5a and 5b.

The holder 40a comprises a gripping handle 44. The gripping handle 44 is configured to be gripped by an industrial robot to lift the assembly 38. The gripping handle 44 also provides an intuitive and reliable gripping interface for a human, for example during a maintenance operation. The gripping handle 44 is one example of a lifting structure.

The gripping handle 44 protrudes upwardly (as seen in FIGS. 5a and 5b) from the cable harness 34, here with a length that is approximately 70% of an outer diameter of the cable harness 34. The gripping handle 44 is here shaped as a flat tab-oriented transverse to a longitudinal direction of the cable harness 34. Furthermore, the gripping handle 44 comprises anti-slip features 46 for strengthening a grip thereof. In this example, the gripping handle 44 is a part of the molded body 42.

The holder 40a further comprises an attachment part 48. The attachment part 48 is configured to mechanically connect the holder 40a to a target structure. In this example, the attachment part 48 is a part of the molded body 42. Since both the gripping handle 44 and the attachment part 48 are formed by the molded body 42 in this example, the gripping handle 44, the attachment part 48 and the holding part 12 are fixed with respect to each other with a very efficient manufacturing method. The gripping handle 44 may however be fixed with respect to the attachment part 48 in alternative ways. For example, one or both of the gripping handle 44 and the attachment part 48 may not form part of a molded body. As can be gathered from FIGS. 5a and 5b, the gripping handle 44, the holding part 12 and the attachment part 48 are aligned along the longitudinal direction of the cable harness 34.

The attachment part 48 of this example comprises two attachment holes 50 and a keying holder notch 52 (see FIG. 5b). The attachment holes 50 are examples of attachment features and the keying holder notch 52 is one example of an orienting holder feature. The attachment part 48 protrudes downwardly (as seen in FIGS. 5a and 5b) from the cable harness 34, here with a length that approximately equals the outer diameter of the cable harness 34. The holding part 12 is thus positioned between the gripping handle 44 and the attachment part 48. The attachment part 48 is here tubular with a substantially quadrilateral profile.

When an industrial robot grips the gripping handle 44 and lifts the assembly 38, the shape of the cable harness 34 can be held intact or substantially intact by the stabilizing element 30. Furthermore, since the attachment part 48 is positioned on an opposite side of the cable harness 34 with respect to the gripping handle 44, the attachment part 48 can efficiently be guided into narrow spaces while the industrial robot holds the gripping handle 44 in order to mount the cable harness 34 to a stationary structure.

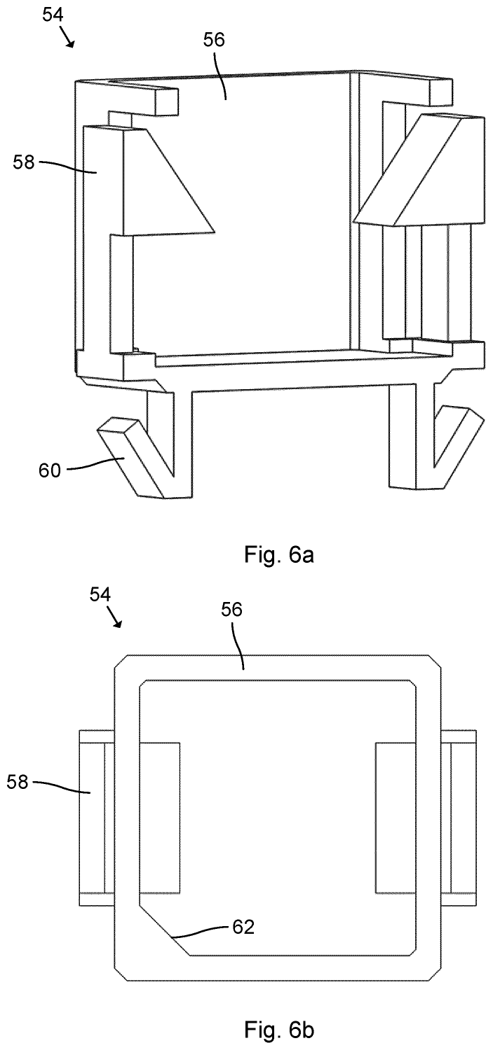

FIG. 6a schematically represents a perspective cross-sectional view of a target element 54, here exemplified as a socket. The target element 54 of this example comprises a target base 56 and two holder latches 58. The holder latches 58 are examples of engaging features. Each holder latch 58 is arranged to flex relative to the target base 56 and is arranged to engage a unique attachment hole 50.

The target element 54 of this example further comprises two target latches 60. The target latches 60 are arranged to flex relative to the target base 56. The target element 54 may be made of plastic.

FIG. 6b schematically represents a top view of the target element 54. As shown, the target element 54 comprises a keying target notch 62. The keying target notch 62 is one example of an orienting target feature. The keying target notch 62 is here provided as an irregularity in the target base 56. The target base 56 has a substantially quadrilateral profile corresponding to the profile of the attachment part 48.

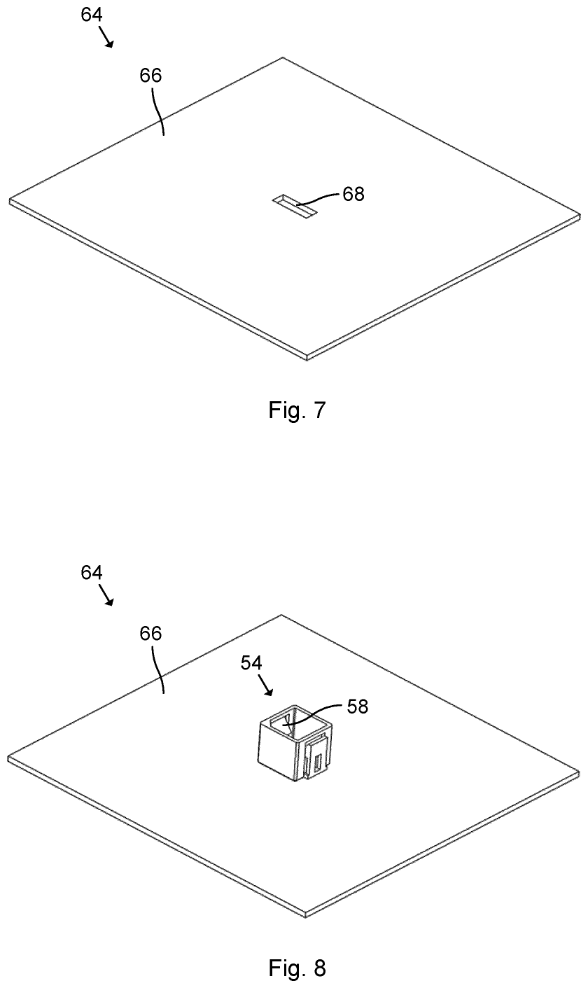

FIG. 7 schematically represents a perspective view of a target structure 64. The target structure 64 of this example comprises a plate 66 of sheet metal. The plate 66 comprises an opening 68. The target structure 64 may for example be a wall of an electric device, such as a control cabinet.

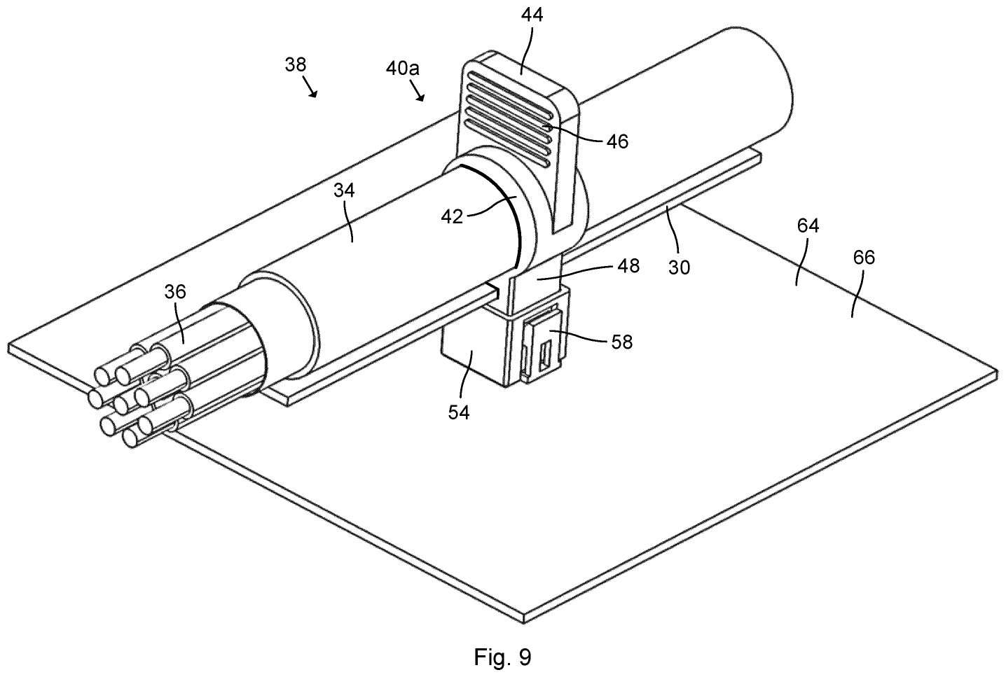

FIG. 8 schematically represents a perspective view of the target structure 64 when comprising the target element 54. The target latches 60 are deformed during insertion of the target element 54 into the opening 68 and snap back to their relaxed state after passing through the opening 68. The target element 54 is thereby fixed to the plate 66 by snap-fit.

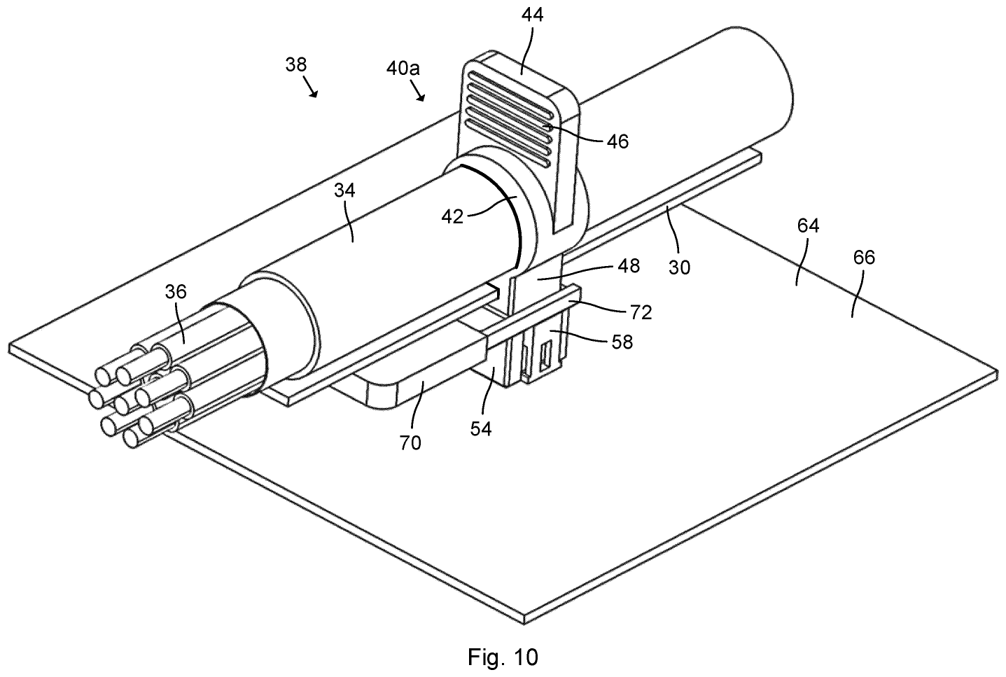

FIG. 9 schematically represents a perspective view of the assembly 38 mechanically connected to the target structure 64. Since the holder 40a comprises both the attachment part 48 and the gripping handle 44, an industrial robot can grip the gripping handle 44, lift and move the assembly 38 such that the attachment part 48 mechanically connects to the target structure 64. In this example, the attachment part 48 enters the target element 54 and the holder latches 58 engage the respective attachment holes 50 to thereby lock the assembly 38 in place. The attachment part 48 thereby connects to the target element 54 by snap-fit. The assembly 38 can thus be connected to the target structure 64 purely by moving the assembly 38 relative to the target structure 64 while using a single grip on the gripping handle 44. No dedicated tools are needed to establish the connection. The assembly 38 therefore enables an increased degree of automation of the installation of the assembly 38 to the target structure 64.

By virtue of the keying target notch 62, the orientation of the target element 54 relative to the plate 66 can be determined unambiguously, for example using machine vision, prior to connecting the assembly 38. Due to the matching keying holder notch 52 of the attachment part 48, the intended position of the assembly 38, and hence also of the cable harness 34, relative to the target structure 64 is known. When the assembly 38 has been mounted to the target structure 64, the keying holder notch 52 aligns with the keying target notch 62. Thereby, an unequivocal orientation of the holder 40a with respect to the target element 54 is defined. By means of the target element 54 made of hard plastic, the molded attachment part 48 can be fixed with respect to the plate 66 made of steel.

FIG. 10 schematically represents a perspective view of the assembly 38 and a tool 70. The tool 70 is used to disconnect the assembly 38 from the target structure 64, for example for maintenance of replacement purposes. The tool 70 of this example comprises two legs 72 (only one is visible in FIG. 10). The legs 72 can engage the holder latches 58 to cause the holder latches 58 to disengage from the attachment holes 50, here by moving the tool 70 downwards (in FIG. 10). The assembly 38 can then be lifted away from the target element 54. A human may manipulate the tool 70 with one hand and pull the gripping handle 44 with the other hand to release and lift the assembly 38 away from the target structure 64. In this way, the serviceability in the field is greatly improved.

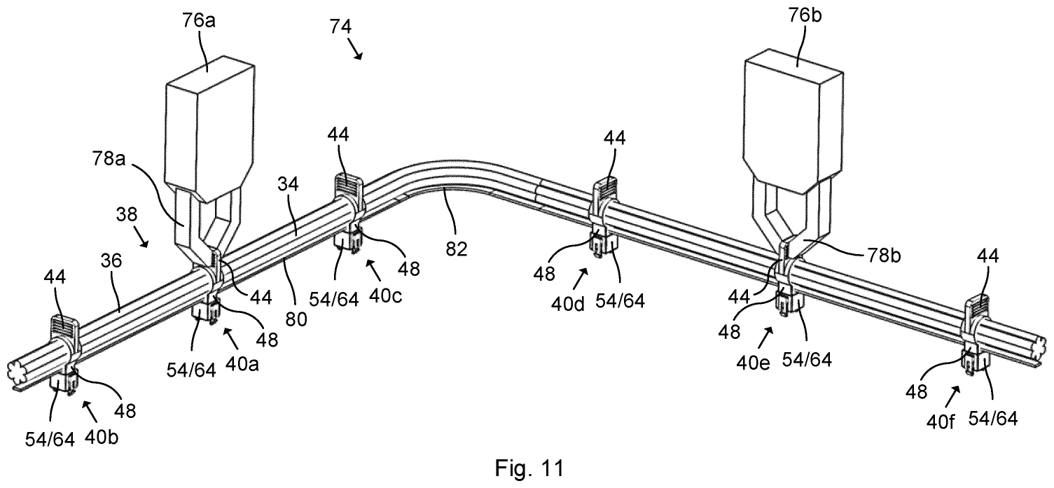

FIG. 11 schematically represents a perspective view of a system 74. FIG. 11 further shows a first industrial robot 76a and a second industrial robot 76b for moving and mounting the system 74. The first industrial robot 76a comprises a first gripper 78a and the second industrial robot 76b comprises a second gripper 78b. The first and second grippers 78a, 78b are examples of end effectors. In FIG. 11, the first gripper 78a is provided on a manipulator of the first industrial robot 76a and the second gripper 78b is provided on a manipulator of the second industrial robot 76b. As one alternative, the first and second grippers 78a, 78b may be provided on a respective first and second manipulator of a single industrial robot. The system 74 may alternatively be moved and connected to the target structure 64 using only a single end effector or using more than two end effectors.

The system 74 comprises the assembly 38 and a plurality of secondary holders 40b-40f, here a second secondary holder 40b, a third secondary holder 40c, a fourth secondary holder 40d, a fifth secondary holder 40e and a sixth secondary holder 40f. Each secondary holder 40b-40f is of the same type as the holder 40a, which can now be referred to as a primary holder. Thus, each secondary holder 40b-40f also comprises a gripping handle 44, a holding part 12 and an attachment part 48 as previously described. In this example, each secondary holder 40b-40f also comprises a molded body 42 as previously described. Each gripping handle 44 has the same positional and orientational relationship with respect to its associated attachment part 48.

The system 74 comprises a stabilizing element 80. The stabilizing element 80 differs from the stabilizing element 30 by comprising a plurality of attachment holes 50, one for each holder 40a-40f, and by comprising a curved section 82. Each attachment hole 50 defines a unique position of each holder 40a-40f along the stabilizing element 80. Each holder 40a-40f is fixed to the stabilizing element 80.

The system 74 enables the cable harness 34 to be arranged in a desired shape in a tidy manner prior to mounting. Moreover, since each gripping handle 44 is associated with an attachment part 48, the industrial robots 76a, 76b can lift, move and mechanically connect the cable harness 34 while gripping a respective one of the gripping handles 44. The system 74 therefore enables a very efficient mounting of the cable harness 34 to the target structure 64 by one or more industrial robots with an increased degree of automation.

Due to the rigidity provided by the stabilizing element 80, the entire system 74 can be mounted to the target structure 64 by an industrial robot. By providing a very rigid stabilizing element 80, the system 74 can be lifted and moved as a single package such that each attachment part 48 is simultaneously connected to its associated target element 54. By providing a slightly flexible stabilizing element 80, such as made of PVC, the industrial robots 76a, 76b can grab, move and push two of the gripping handles 44 such that the associated attachment parts 48 are mechanically connected to the associated target elements 54. The remaining attachment parts 48 may be connected to the associated target elements 54 subsequently by the industrial robots 76a, 76b. By increasing the number of holders 40a-40f, the system 74 can be more rigidly secured to the target structure 64. A relatively large number of holders 40-40f may for example be used when the target structure 64 will be subjected to vibrations. In case the cable harness 34 is relatively short, a single holder 40a-40f can suffice.

The system 74 enables a very efficient automatic handling of cable harnesses of complex shapes. For example, since the cable harness 34 follows the shape of the stabilizing element 80, a vision system can more efficiently recognize the respective components of the system 74.

Although not shown in FIG. 11, one or more cables 36 may branch out from the cable harness 34 at one or several locations. Due to the molded bodies 42, it will be immediately evident if any of the cables 36 has been exchanged or if a routing of any of the cables 36 has changed since the molding in these cases has to be broken. The system 74 as shown in FIG. 11 can be produced and delivered to a production site by a manufacturer.

Although a single stabilizing element 80 passes through all holders 40a-40f in FIG. 11, the stabilizing element 80 does not have to pass through all holders 40a-40f. Optionally, the curved section 82 can be omitted such that the cable harness 34 is supported by two different stabilizing elements and such that a portion of the cable harness 34 is unsupported and allowed to bend. This may additionally improve automated mounting of the cable harness 34 in some implementations and the cable harness 34 can be transported in a more compact state.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. An assembly for being mounted to a target structure, the assembly comprising:
one or more lines; and
a holder including:
a holding part holding the one or more lines;
an attachment part fixed with respect to the holding part, the attachment part being configured to mechanically connect the holder to the target structure; and
a lifting structure for being engaged by an industrial robot to lift the assembly, the lifting structure being fixed with respect to the attachment part.

2. The assembly according to claim 1, wherein the holding part is positioned between the lifting structure and the attachment part.

3. The assembly according to claim 1, wherein the assembly comprises a cable harness, and wherein the one or more lines are a plurality of electric cables of the cable harness.

4. The assembly according to claim 1, further comprising a stabilizing element fixed with respect to the holding part and supporting the one or more lines outside of the holding part.

5. The assembly according to claim 4, wherein the stabilizing element is hidden from view by the one or more lines in at least one viewing direction, and visible in at least one viewing direction.

6. The assembly according to claim 1, wherein the attachment part comprises one or more attachment features configured to attach to a target element of the target structure by snap-fit.

7. The assembly according to claim 1, wherein the holder comprises a molded body molded over the one or more lines.

8. The assembly according to claim 7, wherein the molded body comprises the lifting structure.

9. The assembly according to claim 7, wherein the molded body comprises the attachment part.

10. A system comprising an assembly for being mounted to a target structure, the assembly including:
one or more lines; and
a holder including:
a holding part holding the one or more lines;
an attachment part fixed with respect to the holding part, the attachment part being configured to mechanically connect the holder to the target structure; and
a lifting structure for being engaged by an industrial robot to lift the assembly, the lifting structure being fixed with respect to the attachment part, and at least one secondary holder, wherein each secondary holder includes:
a holding part holding the one or more lines;
an attachment part fixed with respect to the holding part, the attachment part being configured to mechanically connect the secondary holder to the target structure; and
a lifting structure for being engaged by the industrial robot to lift the secondary holder, the lifting structure being fixed with respect to the attachment part.

11. The system according to claim 10, when comprising an assembly further including a stabilizing element fixed with respect to the holding part and supporting the one or more lines outside of the holding part, wherein the stabilizing element is fixed with respect to the holding part of each secondary holder.

12. The system according to claim 10, wherein each lifting structure has the same positional and orientational relationship with its associated attachment part.

13. The system according to claim 10, further comprising a plurality of target elements, wherein each attachment part is configured to be attached to a unique target element.

14. The system according to claim 13, wherein each attachment part is configured to be attached to a unique target element by snap-fit.

15. The system according to claim 13, wherein each pair of attachment part and target element defines an unequivocal relative orientation.

16. The assembly according to claim 2, wherein the assembly comprises a cable harness, and wherein the one or more lines are a plurality of electric cables of the cable harness.

17. The assembly according to claim 2, further comprising a stabilizing element fixed with respect to the holding part and supporting the one or more lines outside of the holding part.

18. The assembly according to claim 2, wherein the attachment part comprises one or more attachment features configured to attach to a target element of the target structure by snap-fit.

19. The assembly according to claim 2, wherein the holder comprises a molded body molded over the one or more lines.
